(19) United States
(12) Patent Application Publication
(10) Pub. No.: US 2026/0294174 A1
(43) Pub. Date: Oct. 1, 2026

(54) LOCKING ASSEMBLY OF KITCHEN APPLIANCE

(71) Applicant: HCL Technologies Limited, New Delhi (IN)

(72) Inventors: Shant kumar, Bengaluru (IN); Yuvraj D. Patil, Kolhapur (IN)

(21) Appl. No.: 19/342,728

(22) Filed: Sep. 29, 2025

(30) Foreign Application Priority Data
Mar. 25, 2025 (IN) 202511028163

(51) Int. Cl. A47J 43/07; A47J 31/44; A47J 31/52

(52) U.S. Cl. CPC A47J 43/0766; A47J 31/4439; A47J 31/5253

(57) ABSTRACT

The present disclosure relates to a locking assembly for locking a food processing jar to a kitchen appliance. The locking may include a flange and a plurality of first-type locking buttons disposed circumferentially about a center of the flange. Further, the locking assembly may include a plurality of second-type locking buttons disposed circumferentially on the flange and sequentially to the plurality of first-type locking buttons. Further, each first-type locking button may be sequential to each second-type locking button. Further, the locking assembly may include a central button disposed on the center of the flange. The plurality of the first-type locking buttons, the plurality of second-type locking buttons, and the central button are configured to adaptively engage to a plurality of locking tabs of a coupler of the food processing jar.

### DESCRIPTION

### TECHNICAL FIELD

This disclosure relates generally to a multipurpose kitchen appliance, and more particularly to a locking assembly for locking a food processing jar to a kitchen appliance.

### BACKGROUND

Modern kitchens are typically equipped with modern kitchen appliances to enhance the quality and efficiency of household tasks. However, each kitchen appliance is designed to serve a single task. Particularly, the locking coupler of the kitchen appliance is typically designed to accommodate and lock a single type of food processing jar. Hence multiple kitchen appliances need to be purchased in order to perform multiple tasks with different types of food processing jars resulting in an increase of the overall cost of kitchen appliances.

Additionally, as the kitchen design modernizes, the available space on the kitchen countertop is reducing, posing a challenge in storing multiple kitchen appliances. As each kitchen appliance comes with its own base equipment, food processing jars, and accessories, which further complicates the storage issue. Moreover, as each kitchen appliance requires its own power outlet to operate, multiple power outlets are required to operate multiple kitchen appliances contemporaneously. As a result, overall power consumption increases, which eventually leads to higher utility cost.

Therefore, there is a pressing need to address the above shortcomings and provide a kitchen appliance that is versatile, cost-effective, and can meet a wide range of consumer needs.

### SUMMARY

In an embodiment, a locking assembly for locking a food processing jar to a kitchen appliance is disclosed. The locking assembly may include a flange and a plurality of first-type locking buttons disposed circumferentially about a center of the flange. Further, the locking assembly may include a plurality of second-type locking buttons disposed circumferentially on the flange and sequentially to the plurality of first-type locking buttons. Further, each first-type locking button may be sequential to each second-type locking button. Further, the locking assembly may include a central button disposed on the center of the flange. The plurality of the first-type locking buttons, the plurality of second-type locking buttons, and the central button may be configured to adaptively engage to a plurality of locking tabs of a coupler of the food processing jar.

In another embodiment, a kitchen appliance is disclosed. The kitchen appliance may include a base and a locking assembly disposed in the base. The locking assembly may be configured to lock and rotate a coupler of a food processing jar relative to the base. The locking assembly may include a flange and a plurality of first-type locking buttons disposed circumferentially about a center of the flange. Further, the locking assembly may include a plurality of second-type locking buttons disposed circumferentially on the flange and sequentially to the plurality of first-type locking buttons. Further, each first-type locking button may be sequential to each second-type locking button. Further, the locking assembly may include a central button disposed on the center of the flange. The plurality of the first-type locking buttons, the plurality of second-type locking buttons, and the central button may be configured to adaptively engage to a plurality of locking tabs of a coupler of the food processing jar.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a perspective view of a kitchen appliance, in accordance with an embodiment of the present disclosure.

FIG. 2 illustrates an exploded view of the kitchen appliance, in accordance with an embodiment of the present disclosure.

FIG. 3 illustrates a cross-sectional view of the kitchen appliance, in accordance with an embodiment of the present disclosure.

FIG. 4 illustrates a first perspective view of a locking assembly of the kitchen appliance, in accordance with an embodiment of the present disclosure.

FIG. 5 illustrates a second perspective view of the locking assembly of the kitchen appliance, in accordance with an embodiment of the present disclosure.

FIG. 6 illustrates a third perspective view of the locking assembly of the kitchen appliance, in accordance with an embodiment of the present disclosure.

FIG. 7 illustrates a functional block diagram of the kitchen appliance, in accordance with an embodiment of the present disclosure.

FIG. 8 illustrates a functional module diagram of the kitchen appliance, in accordance with an embodiment of the present disclosure.

FIG. 9 illustrates a schematic view of the kitchen appliance equipped with a grinder jar, in accordance with an embodiment of the present disclosure.

FIG. 10 illustrates a schematic view of the kitchen appliance equipped with a juicer, in accordance with an embodiment of the present disclosure.

FIG. 11 illustrates a schematic view of the kitchen appliance equipped with a mixer jar, in accordance with an embodiment of the present disclosure.

FIG. 12 illustrates a schematic view of the kitchen appliance equipped with a kettle, in accordance with an embodiment of the present disclosure.

FIG. 13 illustrates a schematic view of the kitchen appliance equipped with an induction pan, in accordance with an embodiment of the present disclosure.

FIG. 14 illustrates a top view of the kitchen appliance, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

As explained earlier, the existing kitchen appliances are designed to serve a single task. Particularly, the locking coupler of the kitchen appliance is typically designed to accommodate and lock a single type of food processing jar. Hence, multiple kitchen appliances need to be purchased in order to perform multiple tasks with different types of food processing jars, thereby increasing the overall cost of the kitchen appliances.

To this end, a locking assembly for locking a food processing jar to a kitchen appliance is disclosed. The locking assembly may include a flange, a plurality of first-type locking buttons disposed circumferentially about a center of the flange. Further, the locking assembly may include a plurality of second-type locking buttons disposed circumferentially on the flange and sequentially to the plurality of first-type locking buttons. Further, each first-type locking button may be sequential to each second-type locking button. Further, the locking assembly may include a central button disposed on the center of the flange. The plurality of the first-type locking buttons, the plurality of second-type locking buttons, and the central button may be configured to adaptively engage to a plurality of locking tabs of a coupler of the food processing jar. Hence, a single locking assembly may be capable of accommodating and locking different types of food processing jars, eliminating the need for purchasing different kitchen appliances.

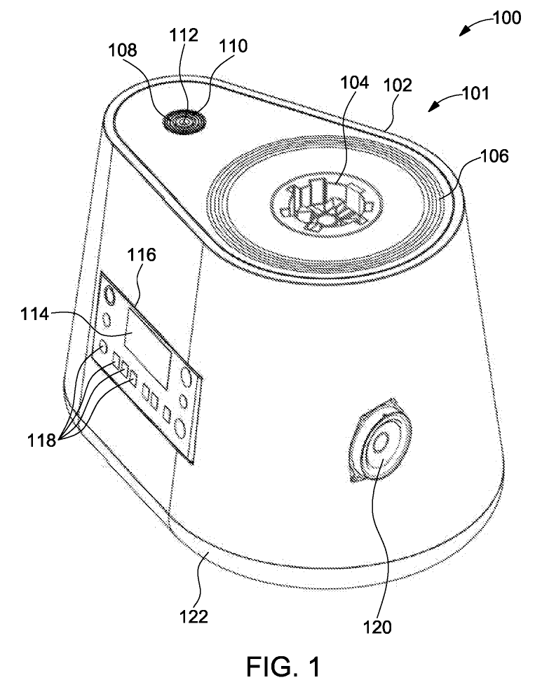

Referring now to FIG. 1, which illustrates a perspective view 101 of the kitchen appliance 100, in accordance with an embodiment of the present disclosure. The kitchen appliance 100 may be shaped as an asymmetrical top surface with a wider bottom surface. The wider bottom surface ensures the kitchen appliance 100 remains stable during operation, preventing tipping while handing high-speed or high torque functions.

Further, the kitchen appliance 100 may include a base 102. The base 102 may include a locking assembly 104 accommodated in the base 102. The locking assembly 104 may be configured to lock a coupler of a food processing jar relative to the base 102. The food processing jar may include any one of a mixer jar, a juicer jar, a grinder jar, a blender jar, a preparation jar, a chopping jar, and the like. Further, the base 102 may include an induction coil 106 disposed in the base 102 and radially disposed around the locking assembly 104. The induction coil 106 may be made of material which is highly conductive and capable of withstanding high temperatures, such as but not limited to copper, aluminum, stainless steel, enamel-coated copper or steel, ferrite, and the like. The induction coil 106 may be used for cooking food in an induction vessel.

Further, the base 102 may include a kettle coil 108 disposed within the base 102. The kettle coil 108 may be configured to engage a kettle. The kettle coil 108 may include a dual press spring-based (DPS) lock mechanism 110 disposed within the kettle coil 108. Further, a single press of the kettle on the DPS lock mechanism 110 may be configured to lock and engage the kettle to the kettle coil 108. Accordingly, a double press of the kettle on the DPS lock mechanism 110 may be configured to unlock and disengage the kettle from the kettle coil 108.

The kettle coil 108 may further include a central connector 112, disposed at the center of the kettle coil 108, which may align with the bottom surface of the kettle, allowing electricity to pass through when the kettle is engaged with the kettle coil 108.

Hence, the kitchen appliance 100 may be capable of performing multiple operations. In an embodiment, the kitchen appliance 100 may perform the function of a food processor by coupling a food processing jar to the locking assembly 104. In another embodiment, the kitchen appliance 100 may be used for cooking food by placing the induction vessel on the induction coil 106. In another embodiment, the kitchen appliance 100 may be used to boil liquid in the kettle by engaging the kettle with the kettle coil 108. It is to be noted that the kitchen appliance 100 may be configured to operate one operation at a time.

Further, the kitchen appliance 100 may include a display unit 114. The kitchen appliance 100 may interact with a user via the display unit 114 accessible via the user interface 116. The display unit 114 may display real-time information such as but not limited to, temperature, operation mode, timer, and the like. The user interface 116 may include a plurality of keys 118 for selecting different operations, adjusting settings, starting/stopping the kitchen appliance 100, and the like. The plurality of keys 118 may include but not limited to power ON/OFF tab, temperature setting tab, timer setting tab, operation mode tab, and the like. The user interface 116 may allow the user to switch between multiple operations of the kitchen appliance 100. The user interface 116 may also include a LED indicator that may light up when a specific operation of the kitchen appliance 100 may be in an operation state.

Further, the kitchen appliance 100 may be integrated with an entertainment system 120, such as but not limited to a built-in music speaker, which may be wirelessly connected to a computing system to play the music. Further, the kitchen appliance 100 may include a LED light 122 installed at the bottom of the kitchen appliance 100 that may synchronize with the bass of the music being played by the entertainment system 120.

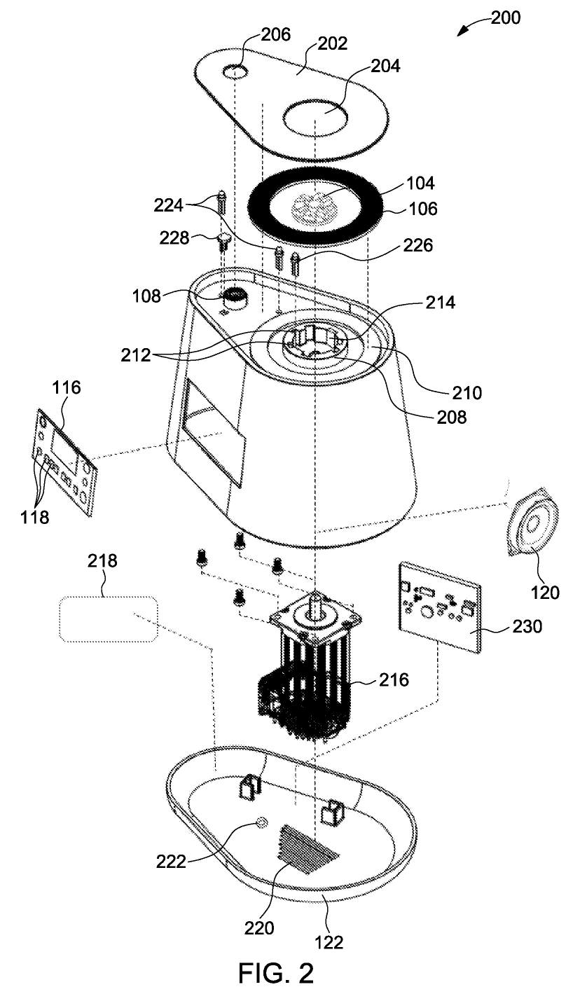

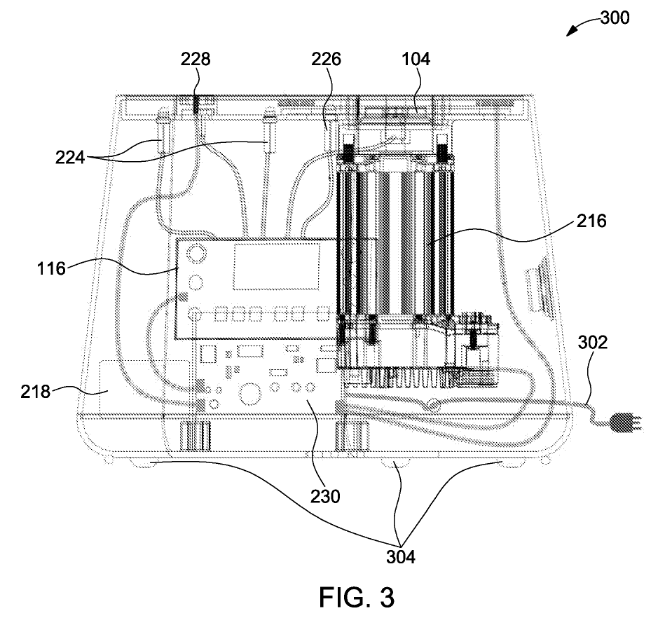

Referring now to FIG. 2, which illustrates an exploded view 200 of the kitchen appliance 100, and FIG. 3 which illustrates a cross-sectional view 300 of the kitchen appliance 100, in accordance with an embodiment of the present disclosure.

As evident in FIG. 2, the kitchen appliance 100 may include a base plate 202. The base plate 202 may include a first opening 204 and a second opening 206. The first opening 204 may be configured to receive a locking assembly 104, and a second opening 206 may be configured to receive a kettle coil 108. The kitchen appliance 100 may further include an induction coil 106 positioned within the base 102 and radially surrounding the locking assembly 104.

Further, the upper portion of the base 102 may include a lock assembly housing 208 and an induction coil housing 210 radially surrounding the lock assembly housing 208. The locking assembly 104 may be arranged centrally within the lock assembly housing 208 of the base 102, and the induction coil 106 may be disposed over the induction coil housing 210. The lock assembly housing 208 may include a plurality of slots 212 configured to engage one or more locking tabs of a coupler housing of the food processing jars (not shown). The lock assembly housing 208 may further include a tapered switch 214 disposed in the locking assembly 104. The tapered switch 214 may be configured to determine the engagement of the coupler of the food processing jar with the locking assembly 104 in response to the coupler housing of the food processing jar engaging the tapered switch 214. Further, the upper portion of the base 102 may include a kettle coil 108 disposed on the upper portion of the base 102.

Further, the base 102 may include a user interface 116 disposed on a middle portion of the base 102. As explained earlier, the user interface 116 may display real-time information such as but not limited to, temperature, operation mode, timer, and the like. The user interface 116 may include a plurality of keys 118 for selecting different operations, adjusting settings, starting/stopping the kitchen appliance 100, and the like. The plurality of keys 118 may include but not limited to power ON/OFF tab, temperature setting tab, timer setting tab, operation mode tab, and the like. The user interface 116 may allow the user to switch between multiple operations of the kitchen appliance 100. The user interface 116 may also include a LED indicator that may light up when a specific operation of the kitchen appliance 100 may be in an operation state.

Further, the inner portion of the base 102 may include a control circuit 230. The control circuit 230 may be configured to accommodate a controller. Further, the controller may include a processor and a memory. The control circuit 230 may be configured to receive one or more parameters from one or more components of the base 102, which when processed by the control circuit 230, causes the control circuit 230 to transmit a command to one or more components of the base 102. Hence, the control circuit 230 ensures a proper functioning and maintenance of the kitchen appliance 100. It is to be noted that the one or more parameters may include but not limited to the temperature of the base 102, engagement of the locking assembly 104, position of the kettle on the kettle coil 108, position of the induction vessel on the induction coil 106, and the like. Further, the inner portion of the base 102 may include an electric motor 216 communicably coupled to the controller. The electric motor 216, upon receiving the command by the controller, may be configured to rotate the locking assembly 104.

Further, the base 102 may be coupled to a power source. The power source may include a power cord 302 coupled to the base 102 and a power battery 218 disposed within the base 102. The power cord 302 may be configured to be inserted into a standard electrical outlet to supply electric current to the base 102. Upon plugging in the power cord 302, electric current may be supplied to the various components of the base 102, such as the electric motor 216, kettle coil 108, the induction coil 106, entertainment system 120, LED lights 122, and the like. Further, the power battery 218 may act as a power backup in case of a power outage. The power battery 218 may provide electric supply to either an electric motor 216, the kettle coil 108, or the induction coil 106, ensuring continued operation during disruption of electrical supply. The power battery 218 may be recharged by the electric current supplied through the power cord 302 during the operation of the kitchen appliance 100. It is to be noted that the output of the power battery 218 may be contingent upon the capacity of the power battery 218.

The inner portion of the base 102 may be further integrated with an entertainment system 120. The entertainment system 120 may include but not limited to a built-in music speaker, illumination effects, and the like. The entertainment system 120 may connect to a user device via a communication network to play the music. The LED light 122 installed at the bottom portion of the base 102 may contemporaneously synchronize with the bass of the music being played by the entertainment system 120, thereby providing the illumination effect.

The base 102 may further include a vent 220 strategically disposed at a bottom portion of the base 102 to allow hot air to escape while preventing dust or debris from entering the base 102. The vent 220 may be configured to expel the heat generated due to an operation of the electric motor 216, induction coil 106, and the kettle coil 108 in order to prevent overheating of the base 102. The base 102 may further include a plurality of anti-skid feet 304 to prevent slipping of the base 102 on the kitchen countertop during operation. Particularly, when the electric motor 216 runs at high speed, high-frequency vibrations may be generated, which may cause the base 102 to move. Hence, the plurality of anti-skid feet 304 may be used to create friction between the base 102 and the kitchen countertop, thereby preventing movement of the base 102. The plurality of anti-skid 304 feet may be made of material such as but not limited to rubber, silicon, and the like. The base 102 may further include a reset button 222 disposed at the bottom portion of the base 102. Particularly, in case the temperature of the base 102 exceeds the predefined temperature threshold due to prolonged use, excessive load, or blocked vent, the base 102 may automatically shut down. After cooling, upon pressing the reset button 222, the base 102 may restart to restore power. The reset button 222 may prevent premature damage of the base 102 and may increase the lifespan of the base 102.

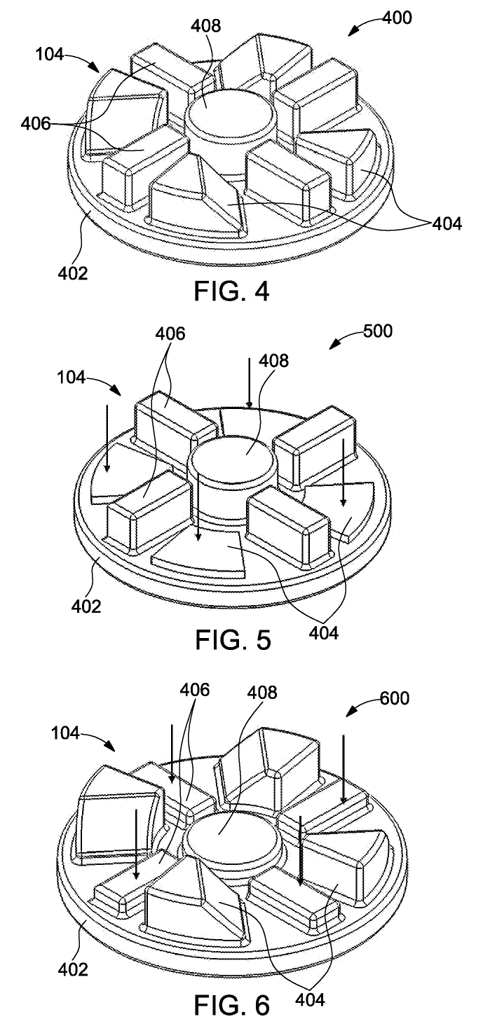

FIG. 4 illustrates a first perspective view 400 of the locking assembly 104 of the kitchen appliance 100, in accordance with an embodiment of the present disclosure. FIG. 5 illustrates a second perspective view 500 of the locking assembly 104, in accordance with an embodiment of the present disclosure. FIG. 6 illustrates a third perspective view 600 of the locking assembly 104, in accordance with an embodiment of the present disclosure.

As explained earlier, the base 102 of the kitchen appliance 100 may include a locking assembly 104 . The locking assembly 104 may be configured to lock and rotate a coupler of a food processing jar relative to the base 102. Further, as evident in FIG. 4, the locking assembly 104 may include a flange 402. Additionally, the locking assembly 104 may include a plurality of first-type locking buttons 404 disposed circumferentially about a center of the flange 402. The locking assembly 104 may further include a plurality of second-type locking buttons 406 disposed circumferentially on the flange 402 and sequentially to the plurality of first-type locking buttons 404. In other words, each first-type locking button 404 may be sequential to each second-type locking button 406. The locking assembly 104 may further include a central button 408 disposed on the center of the flange 402.

Furthermore, each of the first-type locking buttons 404 and each of the second-type locking buttons 406 may include any one of a cuboidal-shaped button or a trapezoidal-shaped button. Additionally, the central button 408 may include a cylindrical-shaped button. It is to be noted that each of the first-type locking buttons 404, each of the second-type locking buttons 406, and the central button 408 are spring-loaded buttons. Furthermore, the plurality of first-type locking buttons 404, the plurality of second-type locking buttons 406, and the central button 408 may adaptively engage with the plurality of locking tabs of the coupler of the food processing jar. It is to be noted that the plurality of locking tabs of the coupler may include any one of a trapezoidal locking tab or a cuboidal locking tab. Accordingly, the engaging of the locking buttons with the locking tabs may include actuation of any one of the cuboidal-shaped buttons 406 or the trapezoidal-shaped buttons 404. Additionally, the central button 408 may or may not be actuated by the coupler based on the configuration of the coupler of the food processing jar. It is to be noted that the trapezoidal-shaped buttons 404 of the locking assembly 104 may be actuated by the trapezoidal locking tabs of the coupler. Conversely, the cuboidal-shaped buttons 406 may be actuated by the cuboidal locking tabs of the coupler. It is to be noted that the central button 408 may or may not be actuated by the plurality of locking tabs of the food processing jar based on the configuration of the coupler of the food processing jar.

In an exemplary embodiment, the coupler of the food processing jar may include the trapezoidal locking tabs. Accordingly, the cuboidal-shaped buttons 406 may be configured to lock the food processing jar to the locking assembly 104, when the trapezoidal-shaped buttons 404 may be actuated vertically downwards by a predefined height by trapezoidal locking tabs of the coupler of the food processing jar. In other words, when the food processing jar with trapezoidal locking tabs may be inserted within a lock assembly housing 208, the trapezoidal locking tabs may actuate the trapezoidal-shaped buttons 404 of the locking assembly 104. As a result, trapezoidal-shaped button 404 may be actuated vertically downward by the predefined height. Subsequently, the cuboidal-shaped buttons 406 may lock the food processing jar with the locking assembly 104, making the locking assembly 104 primed for rotation and the subsequent food processing operation. It is to be noted that the central button 408 may not be actuated by the trapezoidal locking tabs of the food processing jar based on the configuration of the coupler of the food processing jar.

Correspondingly, in another exemplary embodiment, the coupler of the food processing jar may include the cuboidal locking tabs. Accordingly, the trapezoidal-shaped buttons 404 may be configured to lock the food processing jar to the locking assembly 104, when the cuboidal-shaped buttons 406 are actuated vertically downwards by a predefined height by the cuboidal locking tabs of the coupler. In other words, when the food processing jar with cuboidal locking tabs may be inserted within the lock assembly housing 208, the cuboidal locking tabs may actuate the cuboidal-shaped buttons 406 and the central button 408 of the locking assembly 104. As a result, the cuboidal-shaped button 406 and the central button 408 may be actuated vertically downward by the predefined height. Subsequently, the trapezoidal-shaped buttons 404 may lock the food processing jar with the locking assembly 104, making the locking assembly 104 primed for rotation and the subsequent food processing operation.

Hence, the locking assembly 104 may allow the same assembly to adapt to multiple food processing jar configurations, eliminating the need for separate locking assembly 104 for each type of food processing jar. As a result, the kitchen appliance 100 may efficiently handle different food processing jars without the complexity of storage and cost of incorporating multiple locking assemblies.

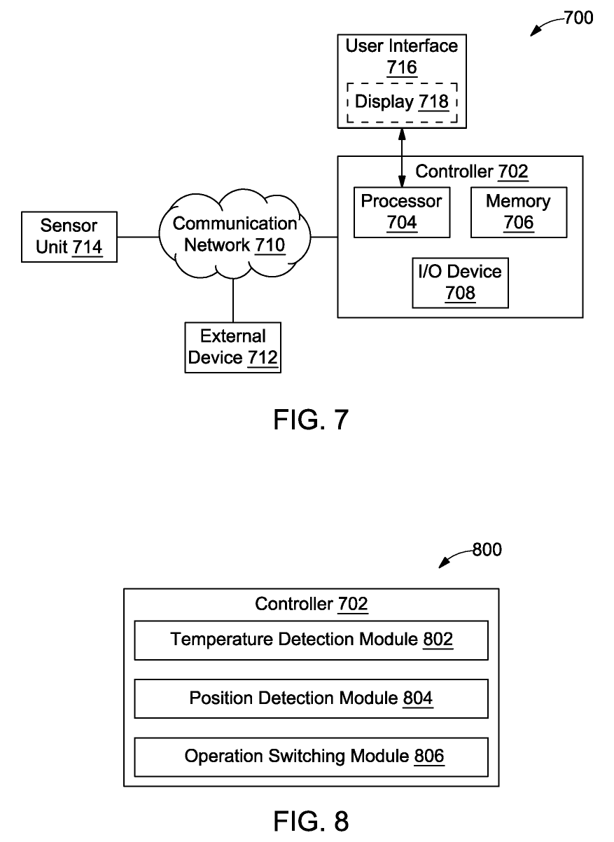

Referring now to FIG. 7, which illustrates a functional block diagram 700 of the kitchen appliance 100, in accordance with an embodiment of the present disclosure. The kitchen appliance 100 may include a controller 702, an external device 712, a user interface 716, and a sensor unit 714 communicably coupled to each other through a wired or wireless communication network 710. The controller 702 may include a processor 704, a memory 706, and an input/output (I/O) device 708.

In an embodiment, examples of processor(s) 704 may include but are not limited to, an Intel^{®} Itanium^{®} or Itanium 2 processor(s), or AMD^{®} Opteron^{®} or Athlon MP^{®} processor(s), Motorola^{®} lines of processors, Nvidia^{®}, FortiSOC™ system on a chip processors or other future processors.

In an embodiment, the memory 706 may store instructions that, when executed by the processor 704, cause the processor 704 to operate the kitchen appliance 100, as will be discussed in greater detail herein below. In an embodiment, the memory 706 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 708 may comprise a variety of interface(s), for example, interfaces for data input, output devices, and the like. The I/O device 708 may facilitate the receiving of instructions by a user communicating with the controller 702. In an embodiment, the I/O device 708 may be wirelessly connected to the controller 702 through wireless network interfaces such as Bluetooth®, infrared, or any other wireless radio communication known in the art. In an embodiment, the I/O device 708 may be connected to a communication pathway for one or more components of the controller 702 to facilitate the transmission of inputted instructions and output results of data generated by various components such as, but not limited to, processor(s) 704 and memory 706.

In an embodiment, the communication network 710 may be a wired or a wireless network or a combination thereof. The communication network 710 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 710 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 710 can include a variety of network devices, including routers, bridges, servers, computing devices, storage devices, and the like.

In an embodiment, as explained earlier, the kitchen appliance 100 may include a user interface 716. The kitchen appliance 100 may interact with a user via a display 718 accessible via the user interface 716. The controller 702 may receive a user input for determining the operation to be performed by the kitchen appliance 100 from an external device 712 through the communication network 710. In an embodiment, the external device 712 may be a computing system, including but not limited to a smartphone, a laptop computer, a desktop computer, a notebook, a workstation, a server, a portable computer, a handheld, or a mobile device. In an embodiment, the controller 702 may be, but not limited to, in-built into the external device 712 or may be a standalone controller 702.

In an embodiment, the sensor unit 714 may be communicably coupled to the controller 702. The sensor unit 714 may be configured to determine one or more parameters from one or more parts of the kitchen appliance 100. The one or more parameters determined by the sensor unit 714 may be transmitted to the controller 702, which, when processed by the processor 704, causes the processor 704 to ensure proper functioning and maintenance of the kitchen appliance 100. It is to be noted that the one or more parameters may include but not limited to temperature, position, operation state, and the like. The sensor unit 714 may include a first sensor (not shown in Fig), a second sensor 226, a position sensor 228, and a plurality of temperature sensors 224.

In an exemplary embodiment, the lock assembly housing 208 of the base 102 may include the first sensor accommodated within the tapered switch 214 disposed in the locking assembly 104. In other words, the tapered switch 214 may be disposed in any one of the plurality of slots 212 of the lock assembly housing 208. The first sensor may be configured to determine the engagement of the tapered switch 214 with a coupler housing of the food processing jar. The first sensor may include but not limited to a hall effect sensor, pressure sensor, capacitive sensor, and the like. Particularly, upon inserting the food processing jar within the lock assembly housing 208, the coupler of the food processing jar may engage with the locking assembly 104. Subsequently, the coupler housing of the food processing jar may engage with the plurality of slots 216 of the lock assembly housing 208. As a result, the tapered switch 214 may get engaged to the coupler housing that may be detected by the first sensor. The first sensor 224 may transmit the collected data to the controller 702.

The controller 702, in response to the data received by the first sensor may transmit the command to an electric motor 216 to enable the rotation of the locking assembly 104 when instructed by the user. Conversely, after the food preparation process, the food processing jar may be removed from the lock assembly housing 208. Upon removing, the coupler of the food processing jar may get disengaged from the locking assembly 104. Subsequently, the tapered switch 214 may get disengaged from the coupler housing of the food processing jar, and the controller 702 may generate a command to disable the rotation of the locking assembly 104. Consequently, the electric motor 216 may be switched off, and the rotation of the locking assembly 104 may be disabled.

Further, the base 102 may include the second sensor 226 coupled to the induction coil 106. The second sensor 226 may be configured to determine a position and contact of an induction vessel relative to the induction coil 106. The second sensor 226 may include but not limited to optical sensor, piezoelectric sensor, ultrasonic sensor, and the like. Particularly, when the induction vessel is placed on the induction coil 106, the second sensor 226 may detect the position and contact of the induction vessel relative to the induction coil 106 and may transmit the collected data to the controller 702.

The controller 702, based on the data received by the second sensor 226 may allow an electricity supply to the induction coil 106 from the power source either from the power battery 218 or the power cord 302. Further, the electric current flowing through the induction coil 106 may create a varying magnetic field to induce an eddy current in the induction vessel. As the induction vessel is magnetic or may have a magnetic bottom surface, the varying magnetic field may induce eddy currents within the bottom surface of the induction vessel. As a result, the eddy current may flow through the surface of the induction vessel. While flowing through the induction vessel, the eddy current may encounter resistance, which may generate heat. Since the heat is generated directly within the induction vessel, that may be transferred to the food, the cooking process is rapid and precise.

In contrast, in case the second sensor 226 detects the induction vessel being distant and separated from the induction coil 106 by a predefined distance, the second sensor 226 may transmit the collected data to the controller 702. The controller 702, based on the data received by the second sensor 226 may generate a command to disconnect the electricity supply to the induction coil 106 from the power source. Consequently, the electricity supply may be cut off from the induction coil 106.

Further, the base 102 may include a position sensor 228 disposed within the kettle coil 108. The position sensor 228 may be configured to determine a position of a kettle on the kettle coil 108. The position sensor 228 may include but not limited to optical sensor, inductive proximity sensor, hall effect sensor, ultrasonic sensor, pressure sensor, and the like. Particularly, when a DPS lock mechanism 110 of the kettle coil 106 may be single pressed by the kettle, the kettle may get locked and engaged with the kettle coil 108. Upon engaging, the position sensor 228 may be configured to detect the position of the kettle and may transmit the collected data to the controller 702. The controller 702, based on the data received by the position sensor 228 may allow the electricity supply to the kettle coil 108 from the power source either from the power battery 208 or the power cord 302. The electricity supply may pass through the central connector 112 disposed at the center of the kettle coil 108 to the bottom surface of the kettle. Upon passing the electricity supply to the bottom surface of the kettle, a heating coil embedded beneath the bottom surface of the kettle may heat up supplying heat energy to the liquid stored within the kettle. Correspondingly, when the DPS lock mechanism 110 may be double pressed by the kettle, the kettle may get unlocked and disengaged with the kettle coil 108. Accordingly, upon detecting by the position sensor 228 the position of the kettle being distant from the kettle coil 108 by a predefined distance, the position sensor 228 may transmit the collected data to the controller 702. The controller 702 based on the data received by the position sensor 228 may generate a command to disconnect the electricity supply to the kettle coil 108 from the power source. Consequently, the electricity supply may be cut off from the kettle coil 108.

Further, the base 102 may include a plurality of temperature sensors 224 disposed within the base 102. The plurality of temperature sensors 224 may be configured to monitor a temperature of the base 102. When either the induction coil 106, or the kettle coil 108 may be operated for a prolonged interval of time, the temperature of the base 102 may rise due to the heat transfer from the induction vessel or kettle to the base 102. During operation of the base 102, the temperature of the base 102 may be detected by the plurality of temperature sensors 224, and the collected data may be transmitted to the controller 702. Accordingly, when the temperature of the induction coil 106 and the kettle coil 108 exceeds a predefined temperature threshold, the controller 702 may generate a command to disconnect the electricity supply to the induction coil 106 and the kettle coil 108. Consequently, the electricity supply may be cut off from the induction coil 106 and the kettle coil 108.

Referring now to FIG. 8, which illustrates a functional module diagram 800 of the kitchen appliance 100, in accordance with an embodiment of the present disclosure. The controller 702 of the kitchen appliance 100 may include a temperature detection module 802, a position detection module 804, and an operation switching module 806.

The temperature detection module 802 may be configured to monitor the temperature of the base 102 based on the sensor data received from the plurality of temperature sensors 224. Particularly, during operation, the temperature of the base 102 may rise due to prolonged use, excessive load, or blocked vent. In case the temperature of the the induction coil 106 and the kettle coil 108 exceeds the predefined temperature threshold, the temperature detection module 802 may generate a command to cut off the electricity supply from the the induction coil 106 and the kettle coil 108, and shutting off the the induction coil 106 and the kettle coil 108.

The position detection module 804 may be configured to determine a position of the induction vessel relative to the induction coil 106 and the position of the kettle on the kettle coil 108. Particularly, when the induction vessel is placed on the induction coil 106, the position detection module 804 may detect the position and contact of the induction vessel relative to the induction coil 106 based on the sensor data received from the second sensor 226. Upon detecting the position and contact of the induction vessel, the position detection module 804 may allow the electricity supply to the induction coil 106 from the power source. In contrast, in case, the induction vessel is being distant and separated from the induction coil 106 by a predefined distance, the position detection module 804 may disconnect the electricity supply to the induction coil 106 from the power source. Similarly, when the kettle is placed on the kettle coil 108, the position detection module 804 may detect the position the kettle based on the sensor data received from the position sensor 228. Upon detecting the position of the kettle, the position detection module 804 may allow the electricity supply to the kettle coil 108 from the power source. Correspondingly, in case, the position of the kettle is distant from the kettle coil 108 by a predefined distance, the position detection module 804 may disconnect the electricity supply to the kettle coil 108.

The operation switching module 806 may be configured to switch between one or more operations based on a user input. The operation switching module 806 may receive the user input either from the user interface 716 or from an external device 712. The operation switching module 806 may be configured to direct the electricity supply to the required component for the selected operation. For instance, in case the user input is kettle coil 108, the operation switching module 806 may direct the electricity supply to the kettle coil 108, while contemporaneously cutting off the electricity supply from the induction coil 106 and the locking assembly 104. Conversely, in case the user input is locking assembly 104, the operation switching module 806 may direct the electricity supply to the electric motor 216 to rotate the locking assembly 104 and disconnect the electricity supply from the induction coil 106 and the kettle induction 108. It is to be noted that the operation switching module 806 may operate the entertainment system 120 and the LED light 122 cooperatively with the locking assembly 104, the kettle coil 108, and the induction coil 106. In another embodiment, the operation switching module 806 may operate the entertainment system 120 and LED lights 122 as a standalone operation.

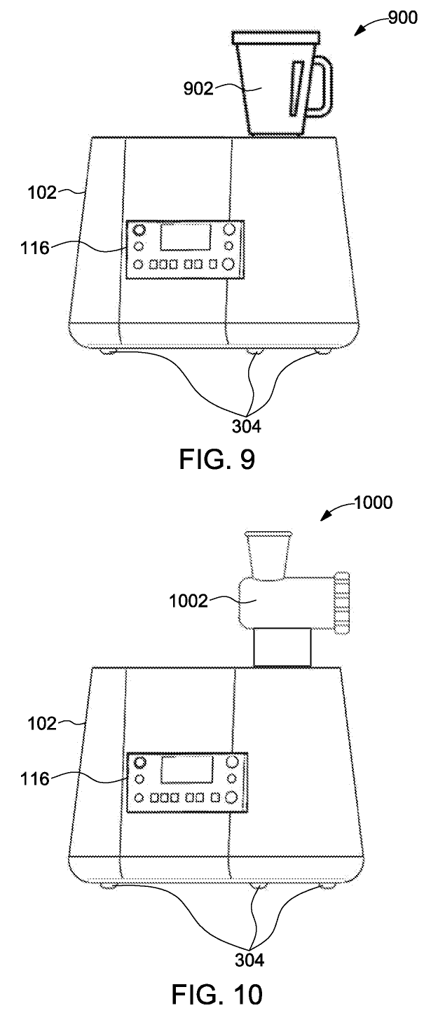

Referring now to FIG. 9, which illustrates a schematic view 900 of the kitchen appliance 100 equipped with a grinder jar 902, in accordance with an embodiment of the present disclosure. As evident in FIG. 9, the grinder jar 902 may be engaged with the locking assembly 104 of the base 102 of the kitchen appliance 100. In an exemplary embodiment, the coupler of the grinder jar 902 may include a plurality of trapezoidal locking tabs. When the grinder jar 902 may be inserted within the lock assembly housing 208 of the base 102. The trapezoidal locking tabs of the grinder jar 902 may actuate the trapezoidal-shaped button 404 of the locking assembly 104. As a result, the trapezoidal-shaped buttons 404 may be actuated vertically downward by a predefined height. Subsequently, the cuboidal-shaped buttons 406 may lock the grinder jar 902 within the locking assembly 104. In parallel to that, the coupler housing of the food processing jar may engage with the plurality of slots 212 of the lock assembly housing 208. As a result, the tapered switch 214 may get engaged to the coupler housing, making the locking assembly 104 primed for rotation and the subsequent food grinding process. Upon engaging, the controller 702 may transmit the command to an electric motor 216 to rotate the locking assembly 104. Upon rotation, the coupler of the grinder jar 902 may also be contemporaneously rotated along with the locking assembly 104 to initiate the food grinding process within the grinder jar 902.

Referring now to FIG. 10, which illustrates a schematic view 1000 of the kitchen appliance 100 equipped with a juicer 1002, in accordance with an embodiment of the present disclosure. As evident in FIG. 10 the juicer 1002 may be engaged with the locking assembly 104 of the base 102. In an exemplary embodiment, the coupler of the juicer 1002 may include a plurality of cuboidal locking tabs. When the juicer 1002 may be inserted within the lock assembly housing 208 of the base 102. The cuboidal locking tabs of the juicer 1002 may actuate the cuboidal-shaped buttons 406 and the central button 408 of the locking assembly 104. As a result, the cuboidal-shaped buttons 406 and the central button 408 may be actuated vertically downward by a predefined height. Subsequently, the trapezoidal-shaped buttons 404 may lock the juicer 1002 within the locking assembly 104. In parallel to that, the coupler housing of the juicer 1002 may engage with the plurality of slots 216 of the lock assembly housing 208. As a result, the tapered switch 214 may get engaged to the coupler housing, making the locking assembly 104 primed for rotation and the subsequent juicing process. Upon actuation, the controller 702 may transmit the command to an electric motor 216 to rotate the locking assembly 104. Upon rotation, the coupler of the juicer 1002 may also be contemporaneously rotated along with the locking assembly 104 to initiate the juicing process within the juicer 1002.

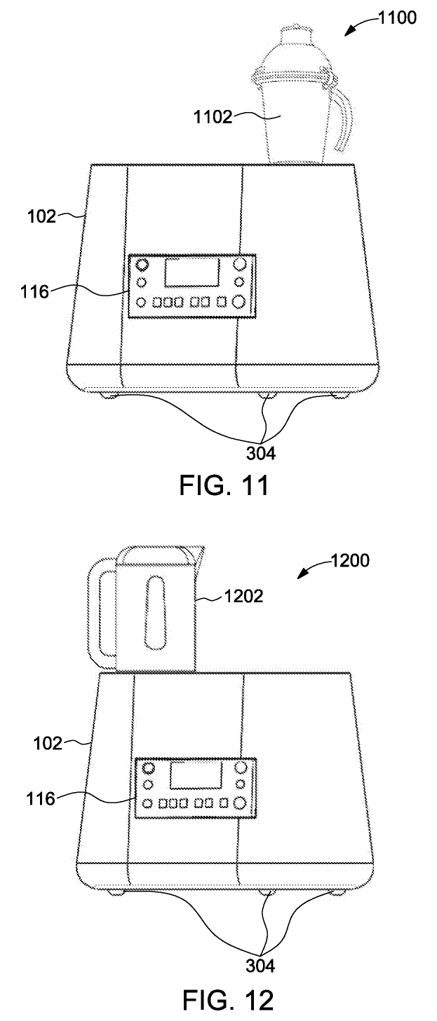

Referring now to FIG. 11, which illustrates a schematic view 1100 of the kitchen appliance 100 equipped with a mixer jar 1102, in accordance with an embodiment of the present disclosure. As evident in FIG. 11, the mixer jar 1102 may be engaged with the locking assembly 104 of the base 102. The coupler of the mixer jar 1102 may include either a plurality of trapezoidal locking tabs or a plurality of cuboidal locking tabs. In case the mixer jar 1102 includes the trapezoidal locking tabs, the mixer jar 1102 may engage with the locking assembly 104 of the base 102 in the same manner as explained in FIG. 9. Conversely, in case the mixer jar 1102 includes cuboidal locking tabs, the mixer jar 1102 may engage with the locking assembly 104 of the base 102 in the same manner as explained in FIG. 10. It is to be noted that the central button 408 may or may not be actuated by the trapezoidal locking tabs or the cuboidal locking tabs of the mixer jar 1102 based on the configuration of the coupler of the mixer jar 1102.

Referring now to FIG. 12, which illustrates a schematic view 1200 of the kitchen appliance 100 equipped with an kettle 1202, in accordance with an embodiment of the present disclosure. As evident in FIG. 12, the kettle 1202 may be engaged with the kettle coil 108. Particularly, when the DPS lock mechanism 110 of the kettle coil 106 may be single pressed by the kettle 1202, the kettle 1202 may get locked and engaged with the kettle coil 108. Upon engaging, the position sensor 228, coupled to the kettle coil 108 may detect the position of the kettle 1202. Upon detecting, the position sensor 228 may transmit the collected data to the controller 702. The controller 702 based on the data received by the position sensor 228 may allow the electricity supply to the kettle coil 108. The electricity supply may pass through the central connector 112 disposed at the center of the kettle coil 108 to the bottom surface of the kettle 1202. Upon passing the electricity supply to the bottom surface of the kettle 1202, a heating coil embedded beneath the bottom surface of the kettle 1202 may heat up, supplying heat energy to the liquid stored within the kettle 1202. As a result, the boiling process of the liquid stored within the kettle 1202 may be initiated.

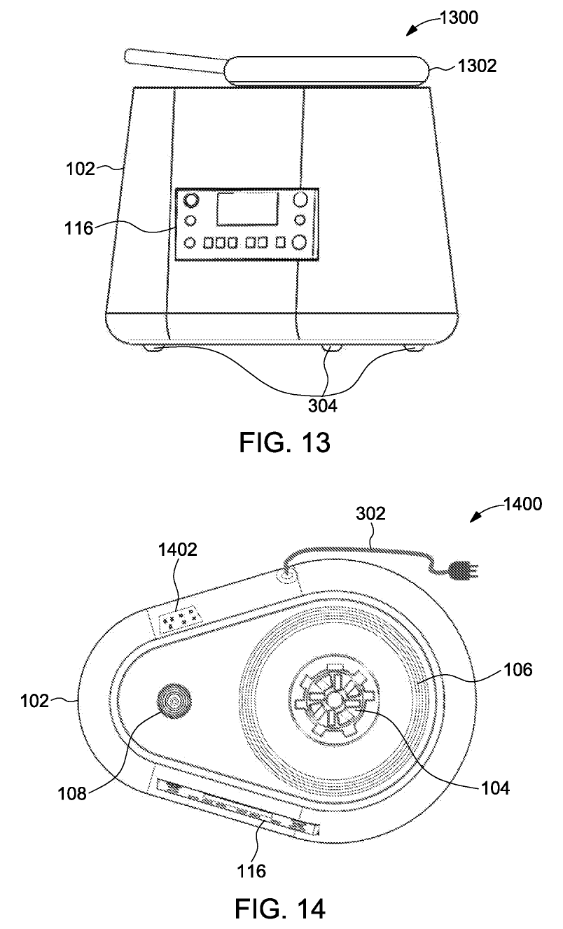

Referring now to FIG. 13, which illustrates a schematic view 1300 of the kitchen appliance 100 equipped with an induction pan 1302, in accordance with an embodiment of the present disclosure. As evident in FIG. 13, the induction pan 1302 may be placed on the induction coil 106. Particularly, when the induction pan 1302 may be placed on the induction coil 106, the second sensor 226 may detect the position and contact of the induction pan 1302 relative to the induction coil 106. Upon detecting, the second sensor 226 may transmit the collected data to the controller 702. The controller 702 based on the data received by the second sensor 226 may allow the electricity supply to the induction coil 106 from the power source. As a result, heat may be generated within the induction pan 1302, which may initiate the cooking process of the food stored within the induction pan 1302.

Referring now to FIG. 14, which illustrates a top view 1400 of the kitchen appliance 100, in accordance with an embodiment of the present disclosure. As evident in FIG. 14, the base 102 of the kitchen appliance 100 may be integrated with an extended power supply 1402. The extended power supply 1402 may be configured to supply power from the power battery 218 to one or more external components connected to the kitchen appliance 100. It is to be noted that the power supplied by the extended power supply 1402 may be contingent upon the capacity of the power battery 218. Additionally, the power battery 218 may be capable of supporting the one or more external components for a predefined interval of time depending upon the power consumption by each component and the capacity of the power battery 218.

As will be appreciated by those skilled in the art, the techniques described in the various embodiments discussed above are not routine, or conventional, or well-understood in the art. The techniques discussed above provide for the locking assembly of the kitchen appliance.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the assembly and working of various components of the kitchen appliance. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A locking assembly for locking a food processing jar to a kitchen appliance, the locking assembly comprising:
a flange;
a plurality of first-type locking buttons disposed circumferentially about a center of the flange;
a plurality of second-type locking buttons disposed circumferentially on the flange, and sequentially to the plurality of first-type locking buttons, wherein each first-type locking button is sequential to each second-type locking button; and
a central button disposed on the center of the flange,
wherein the plurality of the first-type locking buttons, the plurality of second-type locking buttons, and the central button are configured to adaptively engage to a plurality of locking tabs of a coupler of the food processing jar.

2. The locking assembly of claim 1, wherein:
each of the first-type locking buttons and each of the second-type locking buttons comprises any one of:
a cuboidal-shaped button, or
a trapezoidal-shaped button; and
the central button comprises:
a cylindrical-shaped button.

3. The locking assembly of claim 2, wherein each of the first-type locking buttons, each of the second-type locking buttons, and the central button are spring-loaded buttons.

4. The locking assembly of claim 2, wherein the plurality of first-type locking buttons, the plurality of second-type locking buttons, and the central button adaptively engaged to the plurality of locking tabs of the coupler, comprises any one of:
the cuboidal-shaped buttons configured to lock the food processing jar to the locking assembly, when the trapezoidal-shaped buttons are actuated vertically downwards by a predefined height by trapezoidal locking tabs of the coupler of the food processing jar; and
the trapezoidal-shaped buttons configured to lock the food processing jar to the locking assembly, when the cuboidal-shaped buttons are actuated vertically downwards by a predefined height by cuboidal locking tabs of the coupler of the food processing jar.

5. A kitchen appliance, comprising:
a base;
a locking assembly disposed in the base and configured to lock and rotate a coupler of a food processing jar relative to the base, wherein the locking assembly comprises:
a flange;
a plurality of first-type locking buttons disposed circumferentially about a center of the flange;
a plurality of second-type locking buttons disposed circumferentially on the flange, and sequentially to the plurality of first-type locking buttons, wherein each first-type locking button is sequential to each second-type locking button; and
a central button disposed on the center of the flange,
wherein the plurality of the first-type locking buttons, the plurality of second-type locking buttons, and the central button are configured to be adaptively engaged to the plurality of locking tabs of a coupler of the food processing jar.

6. The kitchen appliance of claim 5, wherein:
each of the first-type locking buttons and each of the second-type locking buttons comprises any one of:
a cuboidal-shaped button, or
a trapezoidal-shaped button; and
the central button comprises:
a cylindrical-shaped button.

7. The kitchen appliance of claim 6, wherein each of the first-type locking buttons, each of the second-type locking buttons, and the central button are spring-loaded buttons.

8. The kitchen appliance of claim 7, wherein the first-type locking buttons, the plurality of second-type locking buttons, and the central button adaptively engaged to the plurality of locking tabs of the coupler, comprises any one of:
the cuboidal-shaped buttons configured to lock the food processing jar to the locking assembly, when the trapezoidal-shaped buttons are actuated vertically downwards by a predefined height by trapezoidal locking tabs of the coupler of the food processing jar; and
the trapezoidal-shaped buttons configured to lock the food processing jar to the locking assembly, when the cuboidal-shaped buttons are actuated vertically downwards by a predefined height by cuboidal locking tabs of the coupler of the food processing jar.

9. The kitchen appliance of claim 5, wherein the base comprises:
a plurality of slots configured to engage one or more locking tabs of the food processing jar; and
a tapered switch disposed in the locking assembly, wherein the tapered switch is configured to determine the engagement of the coupler of the food processing jar with the locking assembly in response to a coupler housing of the food processing jar engaging the tapered switch.

10. The kitchen appliance of claim 5, wherein the food processing jar comprises at least one of:
a mixer jar;
a blender jar;
a juicer jar;
a grinder jar;
a preparation jar; and
a chopping jar.

11. The kitchen appliance of claim 5, wherein the base comprises:
an induction coil disposed in the base and radially disposed around the locking assembly.

12. The kitchen appliance of claim 5, wherein the base comprises:
a kettle coil; and
a dual press spring-based (DPS) lock mechanism disposed within the kettle coil,
wherein a single press of the kettle on the DPS lock mechanism is configured to lock and engage with the kettle to the kettle coil, and
a double press of the kettle on the DPS lock mechanism is configured to unlock and disengage the kettle from the kettle coil.

13. The kitchen appliance of claims claim 9-12, comprising:
a sensor unit, comprising:
a first sensor accommodated within the tapered switch, wherein the first sensor is configured to determine engagement of the tapered switch;
a second sensor coupled to the induction coil configured to determine a position and contact of an induction vessel relative to the induction coil;
a position sensor disposed within the kettle coil and configured to determine a position of an kettle on the kettle coil; and
a plurality of temperature sensors disposed within the base and configured to monitor a temperature of the base.

14. The kitchen appliance of claim 13, comprising:
a controller communicably coupled to the sensor unit, configured to:
generate a command to cease rotation of the locking assembly when the tapered switch is disengaged;
generate a command to disconnect an electrical supply to the induction coil from a power source, in response to a determination by the sensor unit, the induction vessel being distant and separated from the induction coil by a predefined distance;
generate a command to disconnect the electrical supply to the kettle coil, in response to a determination by the sensor unit, a position of the kettle distant from the kettle coil by a predefined distance; and
generate a command to disconnect the electrical supply to the induction coil and the kettle coil when in response to a determination by the sensor unit, the temperature of the induction coil and the kettle coil exceeding a predefined temperature threshold.

15. The kitchen appliance of claim 5, wherein the base is integrated with:
an entertainment system; and
an extended power supply.
